(19) United States
(12) Patent Application Publication
(10) Pub. No.: US 2012/0193454 A1
(43) Pub. Date: Aug. 2, 2012

(54) Fuel Injection Valve

(75) Inventors: Yoshio Okamoto, Omitama (JP); Yoshihito Yasukawa, Hitachinaka (JP); Masanori Ishikawa, Tsuchiura (JP); Nobuaki Kobayashi, Maebashi (JP); Takahiro Saito, Isesaki (JP); Noriyuki Maekawa, Kashiwa (JP)

(73) Assignee: Hitachi Automotive Systems, Ltd., Hitachinaka-shi (JP)

(21) Appl. No.: 13/357,657

(22) Filed: Jan. 25, 2012

(30) Foreign Application Priority Data
Jan. 27, 2011 (JP) 2011-014689

(51) Int. Cl. B05B 1/34

(52) U.S. Cl. 239/466

(57) ABSTRACT

There is provided a fuel injection valve, in which uniformity in swirl intensity in a peripheral direction of a swirl fuel is heightened.

A fuel injection valve comprises a valve element 3 and a valve seat 10, which cooperate to open and close a fuel passage to perform injection of a fuel and stoppage of injection, a nozzle body 4 having the valve seat 10, a swirl passage 21 provided downstream of a seat portion 10a, on which the valve element 3 and the valve seat 10 contact with each other, and a swirl chamber 22, to which the swirl passage 21 and a fuel injection port 23 are connected, and a recess (buffer) 24 for enlargement of the swirl chamber 22 in volume is provided on a wall surface portion 4a of the swirl chamber 22 opposed to the fuel injection port 23.

### BACKGROUND OF THE INVENTION

The present invention relates to a fuel injection valve used for internal combustion engines, and more particular, to a fuel injection valve having a plurality of fuel injection ports and causing the respective fuel injection ports to inject a swirl fuel to enable an improvement in atomizing performance.

A fuel injection valve described in JP-A-2003-336562 is known as a prior art, in which atomization of a fuel injected from a plurality of fuel injection ports is accelerated with the use of swirl flow.

With this fuel injection valve, a lateral passage communicated to a downstream end of a valve seat and a swirl chamber, to which a downstream end of the lateral passage is opened tangentially, are formed between a valve seat member, to a forward end surface of which the downstream end of the valve seat cooperating with a valve element is opened, and an injector plate joined to the forward end surface of the valve seat member, and a fuel injection port for injection of a fuel, to which swirl is given in the swirl chamber, is formed in the injector plate, the fuel injection port being arranged offset a predetermined distance toward an upstream end of the lateral passage from a center of the swirl chamber.

Also, with this fuel injection valve, an inner peripheral surface of the swirl chamber is increased in curvature toward a downstream side from an upstream side in a direction along the inner peripheral surface of the swirl chamber. Also, the inner peripheral surface of the swirl chamber is formed along an involute curve having a base circle in the swirl chamber.

With such construction, atomization of a fuel injected from the respective fuel injection ports can be effectively accelerated.

In order that a swirl fuel being symmetrical (uniform) in swirl intensity in a peripheral direction be injected from a fuel injection port, contrivance for a swirl chamber configuration and a flow passage configuration including a lateral passage (a swirl passage) is needed in order to make a swirl flow symmetrical at an outlet of the fuel injection port.

Specifically, in the case where the swirl passage has a cross sectional shape being rectangular and small in passage height along an axis of swirl, symmetry (uniformity) in swirl intensity is lost in the swirl chamber and the fuel injection port. In such case, a fuel about the center of the swirl chamber in flow passage section of the swirl passage flows and reaches early an inlet of the fuel injection port relative to a fuel on an outer peripheral side to be injected, so that ununiformity in swirl intensity in a peripheral direction is caused in the swirl chamber and at the outlet of the fuel injection port.

### SUMMARY OF THE INVENTION

It is an object of the invention to provide a fuel injection valve, in which a swirl fuel is further increased in uniformity in swirl intensity in a peripheral direction.

In order to solve such problem, the invention provides a fuel injection valve comprising a valve element and a valve seat, which cooperate to open and close a fuel passage to perform injection of a fuel and stoppage of injection, a nozzle body having the valve seat, a swirl passage provided downstream of a seat portion, on which the valve element and the valve seat contact with each other, and a swirl chamber, to which the swirl passage and a fuel injection port are connected, and wherein a recess for enlargement of the swirl chamber in volume is provided on a wall surface portion of the swirl chamber opposed to the fuel injection port.

Preferably, the recess has a cross section, which has a spatial shape being trapezoidal in shape, and an upper side (corresponding to a diameter) of the trapezoidal shape has a length being substantially the same as a diameter of the fuel injection port being arranged therebelow and in opposition thereto.

Also, preferably, the recess is smaller in height (depth) than the swirl chamber.

### Effect of the Invention

According to the invention, a fuel having flown into the swirl chamber flows (sucking action) toward the recess (buffer), which is provided above the swirl chamber, to be made a flow, which is once sucked upward. While an intense drift (flow in a passage direction of a swirl passage) is generated in the swirl chamber in a state, in which the recess (buffer) is absent, such intense drift is relieved by an induced flow due to the sucking action into the recess (buffer) with the result that an adequate swirl flow is formed in the swirl chamber and the fuel injection port.

Thereby, a liquid film (being made thin by an adequate swirl intensity) being uniform in a peripheral direction is formed at the outlet of the fuel injection port to enable acceleration of atomization.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross sectional view showing the whole configuration of a fuel injection valve according to a first embodiment of the invention.

FIG. 2 is a cross sectional view showing, in enlarged scale, a lower end of a nozzle body in the fuel injection valve according to the first embodiment.

FIG. 3 is a view showing an orifice plate positioned at the lower end of the nozzle body in the fuel injection valve according to the first embodiment, as viewed from under.

FIGS. 4A, 4B, and 4C are views illustrating a recess according to the first embodiment and the positional relationship between a swirl chamber and a fuel injection port.

FIG. 5 is a diagram illustrating the manner (velocity vectors) of flow in the swirl chamber according to the first embodiment.

FIG. 6 is a diagram illustrating the manner (velocity vectors) of flow in the swirl chamber in the case where a recess (buffer) 24 is absent.

FIG. 7 is a cross sectional view showing, in enlarged scale, a lower end of a nozzle body in a fuel injection valve according to a second embodiment of the invention.

### DETAILED DESCRIPTION OF THE INVENTION

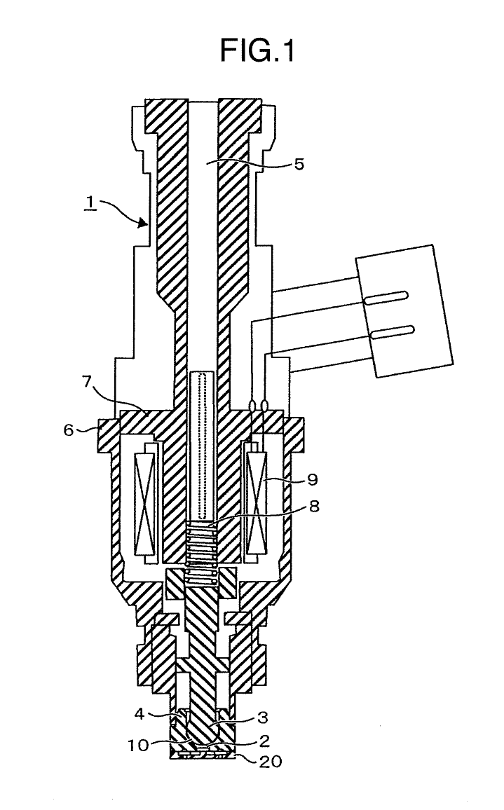

Fuel injection valves according to first and second embodiments of the invention will be described below with reference to FIGS. 1 to 7.

### First Embodiment

The fuel injection valve according to the first embodiment of the invention will be described below in detail with reference to FIGS. 1 to 6.

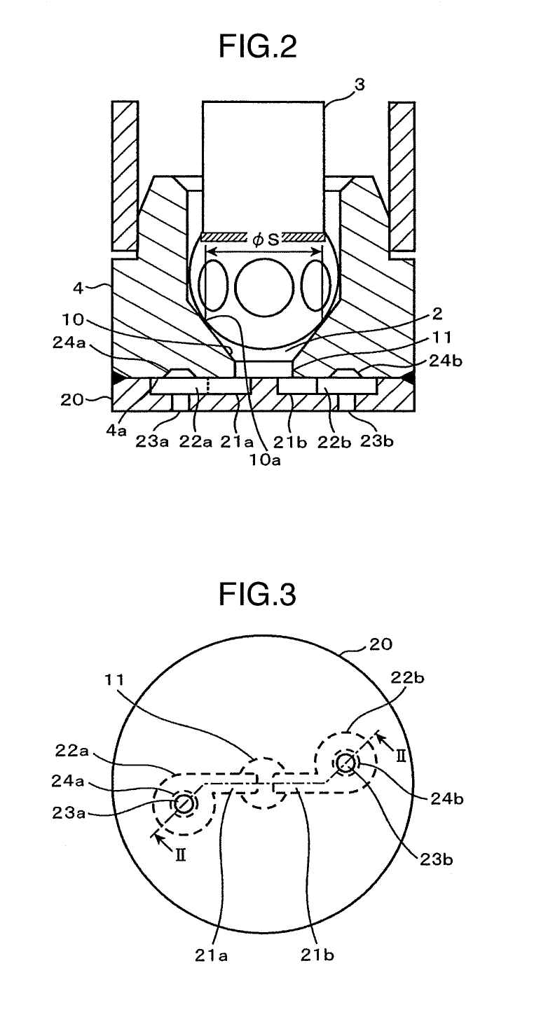

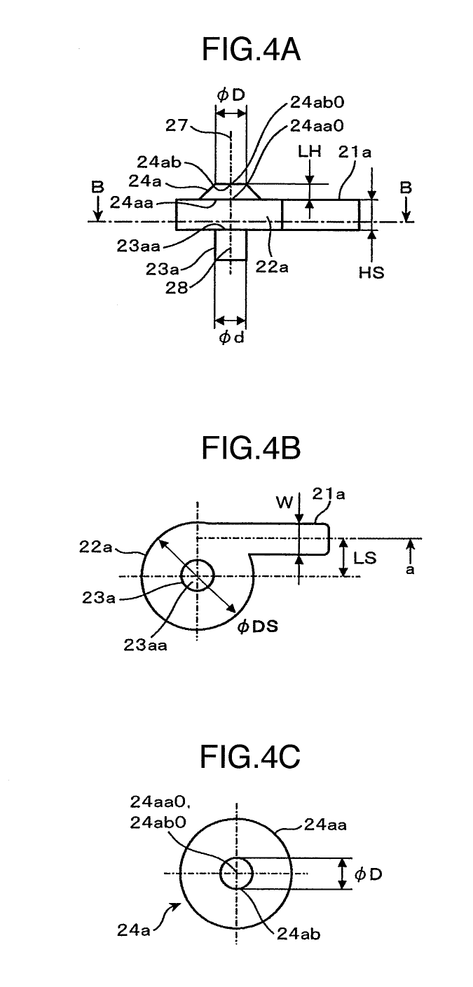

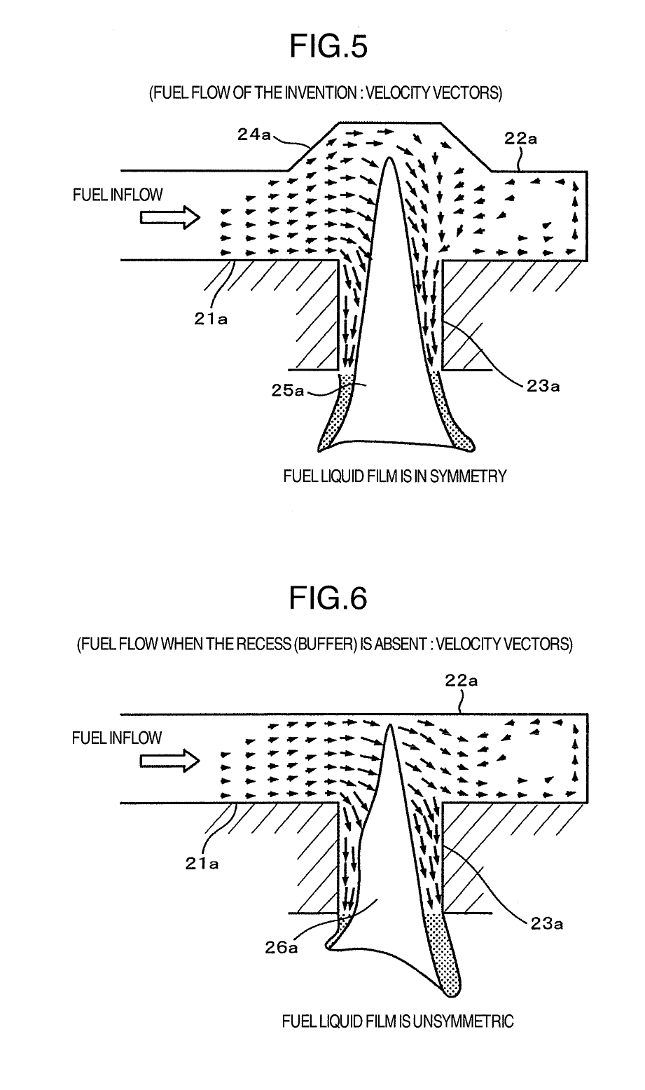

FIG. 1 is a vertical, cross sectional view in a direction along a valve stem of the fuel injection valve according to the first embodiment of the invention. FIG. 2 is a vertical, cross sectional view showing, in enlarged scale, a lower end of a nozzle body in the fuel injection valve according to the first embodiment. FIG. 3 is a view showing an orifice plate positioned at the lower end of the nozzle body in the fuel injection valve according to the first embodiment, as viewed from under. FIGS. 4A to 4C are views illustrating a recess (buffer) according to the first embodiment and the positional relationship between a swirl chamber and a fuel injection port. FIG. 5 is a view illustrating a flow state (represented by velocity vectors) in the swirl chamber according to the first embodiment of the invention. FIG. 6 is a view illustrating a flow state (likewise, represented by velocity vectors) in the swirl chamber without the recess (buffer).

In FIG. 1, a fuel injection valve 1 comprises a yoke 6 made of a magnetic material and surrounding an electromagnetic coil 9, a core 7 positioned centrally of the electromagnetic coil 9 and putting an end thereof into contact with the yoke 6, a valve element 3 adapted for lift of a predetermined quantity, a valve seat surface 10 in contact with the valve element 3, a fuel injection chamber 2, which permits passage of a fuel flowing through a clearance between the valve element 3 and the valve seat surface 10, and an orifice plate 20 having a plurality of fuel injection ports 23a, 23b (see FIG. 2) downstream of the fuel injection chamber 2.

Arranged centrally of the core 7 is a spring 8 serving as an elastic member for pushing the valve element 3 against the valve seat surface 10.

In a state, in which the coil 9 is not energized, the valve element 3 and the valve seat surface 10 are put into close contact with each other. In this state, since a fuel passage is closed, a fuel remains in the fuel injection valve 1 and fuel injection is not performed from the plurality of fuel injection ports 23a, 23b.

On the other hand, when the coil 9 is energized, the valve element 3 is moved by an electromagnetic force until it comes into contact with a lower end surface of the facing core 7. In the valve opened state, a clearance is formed between the valve element 3 and the valve seat surface 10, so that the fuel passage is opened and a fuel is jetted from the plurality of fuel injection ports 23a, 23b.

In addition, a passage 5 is that fuel passage provided in the core 7, through which a fuel pressurized by a fuel pump (not shown) is introduced into the fuel injection valve 1. As the coil 9 is energized (injection pulse) as described above, the fuel injection valve 1 actuates to switch the position of the valve element 3 between a valve opened state and a valve closed state to control a fuel feed rate.

In control of the fuel feed rate, the valve element is designed to eliminate fuel leakage especially in the valve closed state. Fuel injection valves of this kind frequently use balls (steel balls for ball bearings, products according to JIS (Japanese Industrial Standards). The ball is high in roundness to be subjected to mirror finish and effective in improvement in sealing properties.

On the other hand, the valve seat surface 10, with which the ball comes into close contact, has an angle of about 90° (80° to 100°). The valve seat angle is an optimum angle for polishing and heightening the neighborhood of an associated portion (seat position) in roundness to enable maintaining the sealing properties on the ball very high.

A nozzle body 4 with the valve seat surface 10 is increased in hardness by means of hardening and relieved of useless magnetism by means of demagnetizing treatment.

With such structure of the valve element, it is possible to exercise injection quantity control without fuel leakage. Also, it is possible to provide a valve element structure being excellent in terms of cost.

FIG. 2 is a cross sectional view showing, in enlarged scale, a lower end of the nozzle body 4 formed with recesses (buffers) 24a, 24b, which constitute an essential part in the first embodiment of the invention. The neighborhood of swirl passages 21a, 21b, swirl chambers 22a, 22b, the fuel injection ports 23a, 23b, and the recesses (buffers) 24a, 24b is shown in section taken along the line II-II in FIG. 3.

In addition, the vertical relationship in descriptions in the specification and the claims of the present application are based on FIG. 1, the descriptions being given based on the vertical relationship in the case where FIG. 1 is seen so that the orifice plate 20 is positioned below the passage 5.

Provided at the lower end (an opposed surface 4a to the orifice plate 20) of the nozzle body 4 are a fuel introduction hole 11 having a smaller diameter than a seat diameter ΦS of the valve seat surface 10 and the recesses (buffers) 24a, 24b a little distant from the fuel introduction hole 11.

The provision of the recesses (buffers) 24a, 24b at the lower end of the nozzle body 4 has an advantage that positioning relative to the orifice plate 20 is carried out simply and readily to achieve an increase in dimensional accuracy at the time of assembly and a decrease in cost can be achieved owing to a decrease in the number of parts.

Before hardening of the nozzle body 4, the recesses (buffers) 24a, 24b are formed by means of plastic working or the like. In addition, in case of forming after hardening of the nozzle body 4, a method of working such as electrodischarge machining, etc., in which method stresses are not applied comparatively, is preferable.

For the recesses (buffers) 24a, 24b, the swirl chambers 22a, 22b communicated to the respective recesses (buffers) 24a, 24b and the fuel injection ports 23a, 23b provided in positions opposed to the recesses (buffers) 24a, 24b are formed as fuel passages.

While two combinations of the swirl passage 21, the swirl chamber 22, the fuel injection port 23, and the recess (buffer) 24 are provided in the embodiment, such combinations may be increased to thereby heighten the freedom in spray configuration and variation of injection quantity.

Subsequently, a detailed explanation will be given to the configuration of the fuel passage, which is formed by the use of the orifice plate 20 and the nozzle body 4 to comprise the swirl passage 21, the swirl chamber 22, the fuel injection port 23, and the recess (buffer) 24, with reference to FIGS. 3 and 4. FIG. 3 is a view when viewing FIG. 2 from under.

The swirl passages 21a, 21b are connected and communicated to the fuel introduction hole 11 provided centrally of the valve seat surface 10.

The single swirl passage 21 a is communicated and opened to the swirl chamber 22a in a tangential direction and the fuel injection port 23a is opened to a center of the swirl chamber 22a.

Likewise, the single swirl passage 21b is communicated and opened to the swirl chamber 22b in a tangential direction and the fuel injection port 23b is opened to a center of the swirl chamber 22b.

The swirl chambers 22a, 22b may be circular in shape, inner peripheral surfaces of the swirl chambers may be increased in curvature toward a downstream side from an upstream side in directions along the inner peripheral surfaces of the swirl chambers, or inner peripheral surfaces of the swirl chambers may be formed along involute curves having base circles in the swirl chambers.

While directions (directions, in which a fuel flows out), in which the fuel injection ports 23a, 23b are opened, are in parallel to the valve stem of the fuel injection valve and downward in the embodiment, they may be inclined in desired directions to scatter sprays (make respective sprays distant from one another to restrict interference).

With reference to FIGS. 4A to 4C, an explanation will be given to a design method of the swirl chamber having the recess (buffer) 24. FIG. 4A is a view showing only a fuel passage part, which is a combination of the swirl passage 21a, the swirl chamber 22a, the fuel injection port 23a, and the recess (buffer) 24a, which are shown in FIG. 2, and FIG. 4B is a cross sectional view of the fuel passage part taken along the line B-B in FIG. 4A. FIG. 4C is a plan view showing the recess (buffer) 24a as viewed from the fuel injection port 23a.

As described above, combinations of the swirl passages 21a, 21b, the swirl chambers 22a, 22b, the fuel injection ports 23a, 23b, and the recesses (buffers) 24a, 24b are not limited to two in number but more combinations may be provided. Of course, one combination involves no problem. Accordingly, in some cases, suffixes a, b, by which the respective combinations are distinguished from each other, are omitted and the swirl passage, the swirl chamber, the fuel injection port, and the recess (buffer), respectively, are designated as the swirl passage 21, the swirl chamber 22, the fuel injection port 23, and the recess (buffer) 24.

The swirl passage 21a is rectangular in cross section (cross section perpendicular to a flow direction) and designed to dimensions, which are advantageous to press working. In particular, workability is made advantageous by decreasing a height HS of the swirl passage 21a as compared with a width W thereof.

Design is made so that since the rectangular portion provides for a throttle (minimum cross sectional area), a fuel flowing into the swirl passage 21a does not give rise to pressure loss in the fuel passage part (a fuel passage part upstream of the swirl passage 21a) leading to the swirl passage 21a via the fuel injection chamber 2 and the fuel introduction hole 11 from the seat portion 10a of the valve seat surface 10. In particular, the fuel introduction hole 11 is designed to dimensions, which do not give rise to pressure loss due to a large bend.

So-called pressure energy of a fuel is made to be efficiently converted into swirl velocity energy.

Flow accelerated in the rectangular portion is led to the fuel injection port 23a on a downstream side while maintaining an adequate swirl intensity and a so-called swirl velocity energy.

The recess (buffer) 24 is formed as the recesses (buffers) 24a, 24b on the opposed surface 4a to the orifice plate 20 of the nozzle body 4. Since the recesses 24a, 24b are the same in structure, an explanation will be given to the recess 24a.

An opened surface 24aa and a bottom surface 24ab, respectively, of the recess 24a are circular-shaped, and the opened surface 24aa and the bottom surface 24ab are parallel surfaces, the respective surfaces 24aa, 24ab being formed so that centers 24aao, 24abo thereof are present on the same axis 27 perpendicular to the respective surfaces.

The opened surface 24aa of the recess 24 is formed to have a small diameter relative to the diameter ΦD of the bottom surface 24ab, the recess 24 having a cross section, which is in parallel to the axis 27 and trapezoidal in shape as shown in FIG. 4A.

In the embodiment, the bottom surface 24ab of the recess 24 is formed to have substantially the same diameter as that of an inlet opened surface 23aa of the fuel injection port 23a, the opened surface 24aa of the recess 24 is formed to have a larger diameter than that of the inlet opened surface 23aa of the fuel injection port 23a, and the recess (buffer) 24a is formed so that when the inlet opened surface 23aa of the fuel injection port 23a is projected onto the lower end surface 4a of the nozzle body 4, an edge of the opened surface 24aa of the recess (buffer) 24a surrounds a projected region of the inlet opened surface 23aa of the fuel injection port 23a.

Also, in the embodiment, the axis 27 including the center 24aao of the opened surface 24aa and the center 24abo of the bottom surface 24ab agrees with an axis 28 of the fuel injection port 23a. In the case where the fuel injection port 23a is formed to be inclined to a plate surface of the orifice plate 20 instead of being perpendicular thereto, the axis 28 of the fuel injection port 23a does not agree with the axis 27 but it is preferred that the axis 28 of the fuel injection port 23a and the axis 27 intersect on the inlet opened surface 23aa of the fuel injection port 23a. At least, the recess 24a is preferably formed so that the axis 27 intersects the inlet opened surface 23aa of the fuel injection port 23a.

The swirl intensity (swirl number S) of a fuel is indicated by the formula (1).

$$\begin{matrix}S = \frac{d \cdot LS}{n \cdot {ds}^{2}} & Formula ( 1 ) \\ ds = \frac{2 \cdot W \cdot HS}{W + HS} & Formula ( 2 )\end{matrix}$$

Here, d indicates the diameter of the fuel injection port, LS indicates a distance between a center line of the swirl passage W and a center of the swirl chamber DS, and n indicates the number of swirl passages, which is one in the embodiment.

Also, ds indicates a swirl passage as being converted into hydraulic diameter and is represented by the formula (2), W indicates the width of a swirl passage, and HS indicates the height of a swirl passage.

Here, the size of the swirl chamber 22a is described above, its diameter DS being determined so that influences of friction loss due to fuel flow and friction loss on interior chamber walls are made as small as possible. It is said that an optimum value of the size is about four to five times the hydraulic diameter ds, and the value is applied in the embodiment.

The fuel injection port 23a is fairly large in diameter. The diameter acts effectively to adequately enlarge a cavity 25a (see FIG. 5) formed inside. The diameter can be made to act on formation of injected fuel into a thin film without loss of swirl velocity energy.

Further, since the ratio of the diameter of the fuel injection port to the plate thickness (the same as that of the orifice plate 20 except the height of the swirl chamber in this case) of a portion, in which the fuel injection port 23a is formed, is small, loss in swirl velocity energy is very small, Therefore, the atomizing characteristics of a fuel are very excellent.

Further, since the ratio of the diameter of the fuel injection port to the plate thickness of a portion, in which the fuel injection port 23a is formed, is small, an improvement in press workability is achieved. With such structure, since dimensional dispersion is restricted by not only the cost effect but also the improvement in workability, a marked improvement in robust quality is achieved for spray configuration and injection quantity.

FIGS. 5 and 6 illustrate visualization of fuel flow in the swirl chamber to represent the manner of flow in terms of the magnitude of velocity vectors and directions thereof.

FIG. 5 shows results of visualization of fuel flow in the invention and FIG. 6 shows results of visualization of fuel flow when the recess (buffer) 24 is absent.

According to the results of flow shown in FIG. 6, a fuel inflowing from the swirl passage 21a exhibits a flow mode, in which it is accelerated in the swirl chamber 22a and an intense drift flows into the injection port 23a. In the injection port 23a, there are generated many intense flows on the right side in the figure rather than on the left side. Consequently, a cavity 26a formed inside the injection port 23a is unsymmetrical in shape. A so-called liquid film distribution of an injected fuel is unsymmetrical in configuration at an outlet of the injection port 23a.

On the other hand, according to the results of flow, shown in FIG. 5, in the invention, a fuel inflowing from the swirl passage 21a is once sucked toward the recess (buffer) 24a provided above the swirl chamber 22a, so that an intense drift as in the conventional arrangement is hard to generate and such intense drift is much relieved.

Since the recess (buffer) 24a is provided in opposition to the fuel injection port 23a, the sucking effect makes velocity vectors of flow symmetrical as it goes toward the downstream side (toward the outlet). Consequently, the cavity 25a formed inside the injection port 23a is symmetrical in shape. A so-called liquid film distribution of an injected fuel is symmetrical in configuration at the outlet of the injection port 23a.

Also, uniformization in a peripheral direction leads to formation of thin film as compared with the conventional arrangement. Since such fuel spray in the form of a thin film actively exchanges energy with a surrounding air, distribution is accelerated to make an adequately atomized spray.

While the combination of the swirl passage 21a, the swirl chamber 22a, the fuel injection port 23a, and the recess (buffer) 24a has been described, it goes without saying that it is the same as that of the swirl passage 21b, the swirl chamber 22b, the fuel injection port 23b, and the recess (buffer) 24b.

### Second Embodiment

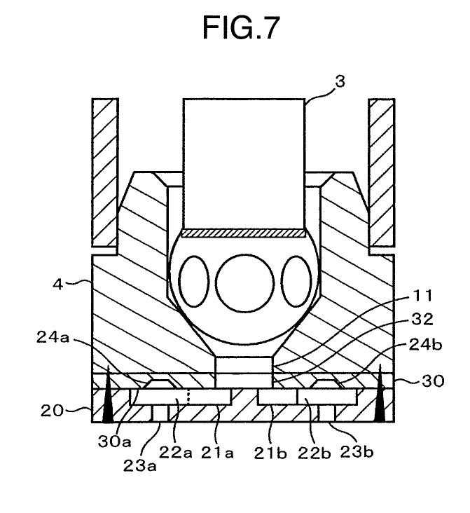

A fuel injection valve according to a second embodiment of the invention will be described below in detail with reference to FIG. 7. FIG. 7 is a view illustrating the structure of an intermediate plate 30 positioned at a lower end of a nozzle body 4 in the fuel injection valve according to the second embodiment of the invention.

What is different from the fuel injection valve according to the first embodiment resides in that the intermediate plate 30 is interposed between the nozzle body 4 and an orifice plate 20 and recesses (buffers) 24a, 24b are provided on an opposed surface 30a of the intermediate plate 30 to the orifice plate 20. After the intermediate plate 30 and the orifice plate 20 are beforehand positioned, assembled, and regulated, they can be fixed to a seat valve 4. Since the parts are beforehand assembled and regulated, a partial assembly can be measured with respect to spray configuration and characteristics of injection quantity and it is possible to modify dispersion among individual parts or the like, so that a spray nozzle body can be made high in robust quality.

The recesses (buffers) 24a, 24b are provided on the intermediate plate 30 and, respectively, disposed in opposed positions to fuel injection ports 23a, 23b, so that the same function and effect as those of the first embodiment can be produced.

The intermediate plate 30 has a desired plate thickness and is formed centrally thereof with a fuel introduction hole 32. A fuel introduction hole 11 is arranged coaxially just above the fuel introduction hole 32 to serve as straightening a flow so that a fuel from the fuel introduction hole 11 does not make a swift flow on the downstream side.

As described above, with the fuel injection valves according to the respective embodiments of the invention, when a swirl fuel is injected from the plurality of fuel injection ports, symmetry is ensured for the respective spray fuels to form a uniform, thin film to thereby accelerate atomization.

Therefore, the recess (buffer) 24 for enlargement of a space in the swirl chamber is provided on the wall surface portion of the swirl chamber 22 opposed to the fuel injection port 23.

A fuel having flown into the swirl chamber 22 flows (sucking action) toward the recess (buffer) 24, which is provided above the swirl chamber, to be made a flow, which is once sucked upward. While an intense drift is generated in the swirl chamber 22 in a state, in which the recess (buffer) 24 is absent, such intense drift is relieved by an induced flow due to the sucking action into the recess (buffer) 24 and an adequate, symmetrical swirl flow is formed in the swirl chamber 22 and the fuel injection port 23 to make a fuel into a thin film.

Since such fuel spray in the form of a thin film actively exchanges energy with a surrounding air, distribution is accelerated to make an adequately atomized spray.

A fuel injection valve being inexpensive and excellent in terms of cost can be provided by making the recess (buffer) 24 simple in flow passage configuration for easy working, carrying out combination fitting for an improvement in assembling quality, eliminating the need for fine adjustment working and generation of defective products, or the like.

It should be further understood by those skilled in the art that although the foregoing description has been made on embodiments of the invention, the invention is not limited thereto and various changes and modifications may be made without departing from the spirit of the invention and the scope of the appended claims.

1. A fuel injection valve comprising a valve element and a valve seat, which cooperate to open and close a fuel passage to perform injection of a fuel and stoppage of injection, a nozzle body having the valve seat, a swirl passage provided downstream of a seat portion, on which the valve element and the valve seat contact with each other, and a swirl chamber, to which the swirl passage and a fuel injection port are connected,
and wherein a recess for enlargement of the swirl chamber in volume is provided on a wall surface portion of the swirl chamber opposed to the fuel injection port.

2. The fuel injection valve according to claim 1, wherein the recess has a cross section, which has a spatial shape being trapezoidal in shape, and an upper side, which constitutes the trapezoidal shape, has a length being the same as a diameter of the fuel injection port.

3. The fuel injection valve according to claim 1, wherein the recess is smaller in height than the swirl chamber.

4. The fuel injection valve according to claim 2, wherein the recess is smaller in height than the swirl chamber.
